(19) United States
(12) Patent Application Publication
(10) Pub. No.: US 2007/0047855 A1
(43) Pub. Date: Mar. 1, 2007

(54) Dual steel ball bearing retainer

(75) Inventor: Yao-Hsun Liu, Shengang Township (TW)

Correspondence Address: EGBERT LAW OFFICES, 412 MAIN STREET, 7TH FLOOR, HOUSTON, TX, 77002, US

(73) Assignee: GAO MING TIE GLOBAL INC., Changhua Hsien (TW)

(21) Appl. No.: 11/406,758

(22) Filed: Apr. 19, 2006

(30) Foreign Application Priority Data
Aug. 23, 2005 (TW) 094214458

(51) Int. Cl. F16C 29/04

(52) U.S. Cl. 384/49

(57) ABSTRACT

The present invention provides a dual steel ball bearing retainer. Dual rows of several round indentations are placed on the bearing retainer element, and the indentations are placed in several dual rows with steel balls inlayed therein. The bearing retainer is placed on the axle, and a housing is placed on an outside, and the movement is created by the friction between the steel ball of the bearing retainer and the housing moving up and down.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a structure of steel ball bearing retainer, and more particularly to a structure with dual steel ball bearing.

### BACKGROUND OF THE INVENTION

As shown in FIG. 1, there is a conventional structure of a single steel ball bearing retainer, which has several round indentations spaced in order on the bearing retainer 1. The indentation has several single rows of steel balls 2. However, when this structure is moved up and down, it has uneven friction. For this reason, the industry developed the steel ball bearing retainer shown in FIG. 2. This steel ball bearing retainer has a single row and is arranged diagonally. It is installed by placing several round indentation spaced diagonally, and the indentation has several of single rows of steel balls 3 placed on it diagonally. When this conventional structure is moved up and down, even though it has larger contacting space and the lesser friction than the structure of steel ball bearing in FIG. 1, the vibration, the effect, and stability is still insufficient. Therefore, the structure is not convenient, has many blind points and concerns still exist, as well as the following disadvantages:
1. When the conventional steel ball bearing moves up and down and because the friction area is large, it vibrates excessively, which reduces precision.
2. When the structure of a single row steel ball bearing is placed and is diagonally moved up and down, even though it has a larger contacting area and the friction is reduced, the vibration, effect and stability is still insufficient.

### BRIEF SUMMARY OF THE INVENTION

The dual steel ball bearing retainer of the present invention has a plurality of dual rows of several round indentations placed on the bearing retainer element, a plurality of steel balls, and a housing. The indentations are placed in several dual rows, having steel balls therein. From this structure, the steel balls are placed diagonally, and each steel ball can be placed in each indentation.

### BRIEF DESCRIPTION OF THE SEVERAL VIEWS OF THE DRAWINGS

FIG. 1 shows a perspective view of the conventional, single row ball bearing retainer.

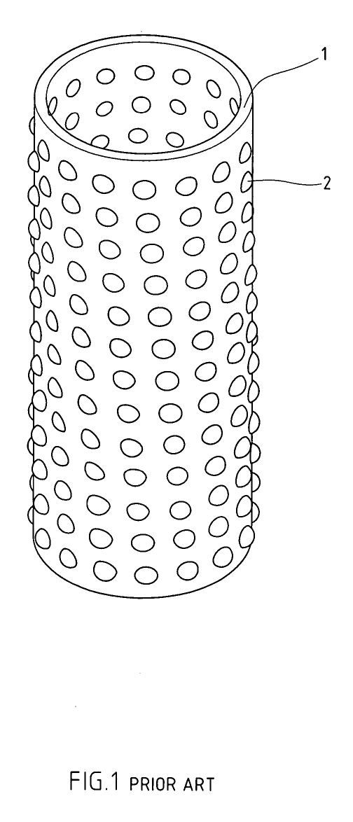

FIG. 2 shows a perspective view of the conventional, single row ball bearing retainer placed diagonally.

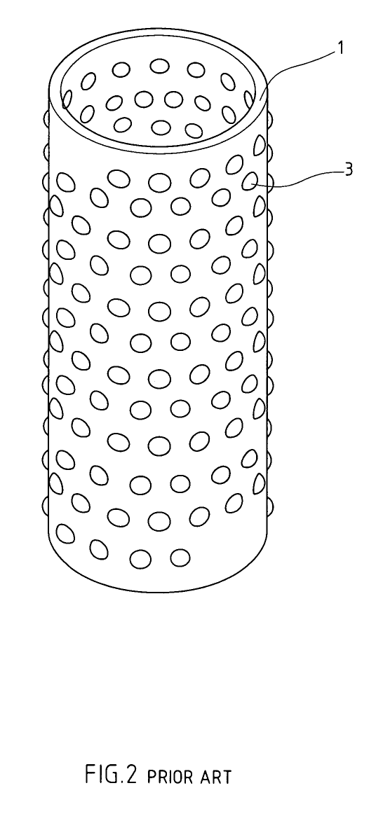

FIG. 3 shows a perspective view of the present invention.

FIG. 4 shows an unfolded elevation view of the present invention.

FIG. 5 shows a perspective view of a steel ball inlayed in the present invention.

FIG. 6 shows a cross-section of the operation of the present invention placed on an axle.

FIG. 7 shows a perspective view of the embodiment of the present invention of FIG. 6.

### DETAILED DESCRIPTION OF THE INVENTION

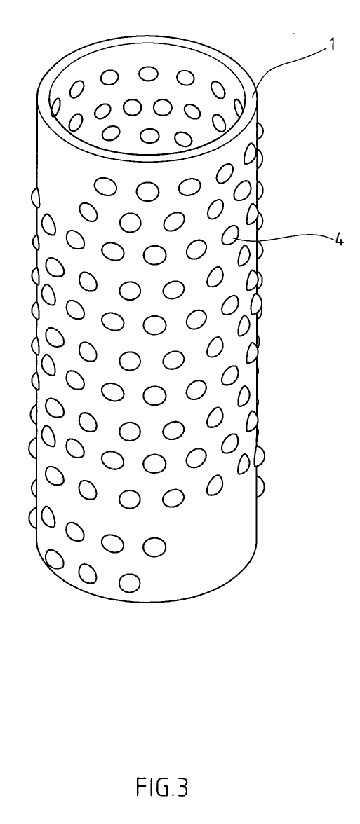

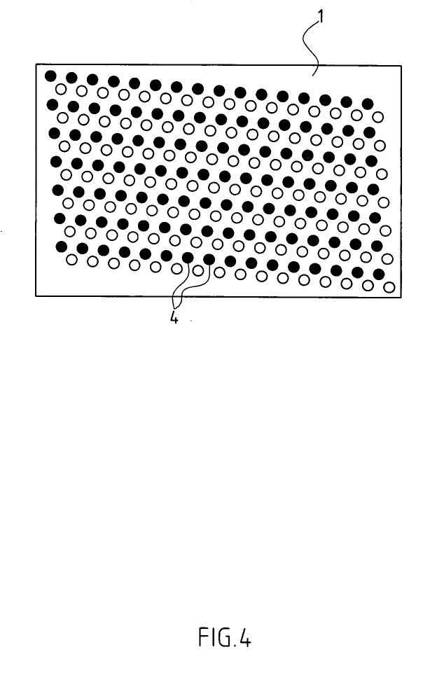

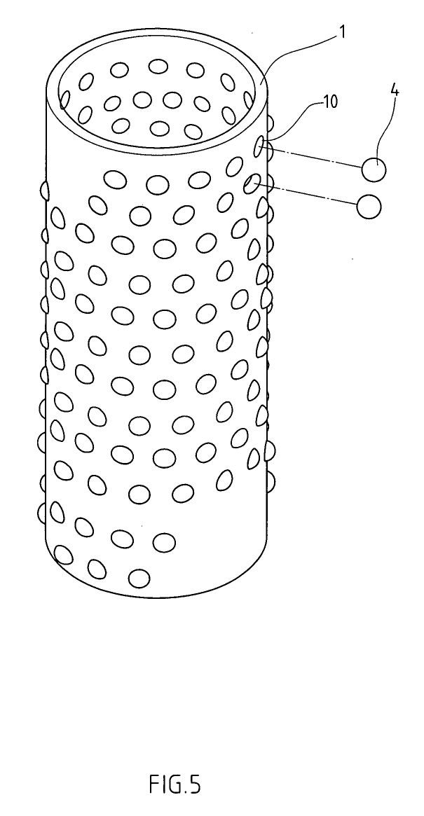

As shown in FIGS. 3-5, there is a preferred embodiment of the improved structure of dual steel ball bearing retainer. Among them, dual rows of several round indentations are placed on the bearing retainer 1, and the indentation 10 mentioned herein consists of several dual rows of steel balls 4. From this structure, the steel balls are placed diagonally, and the steel ball 4 can be placed in the indentation 10. FIG. 5 shows the side the bearing retainer 1, and its actual placement and structure.

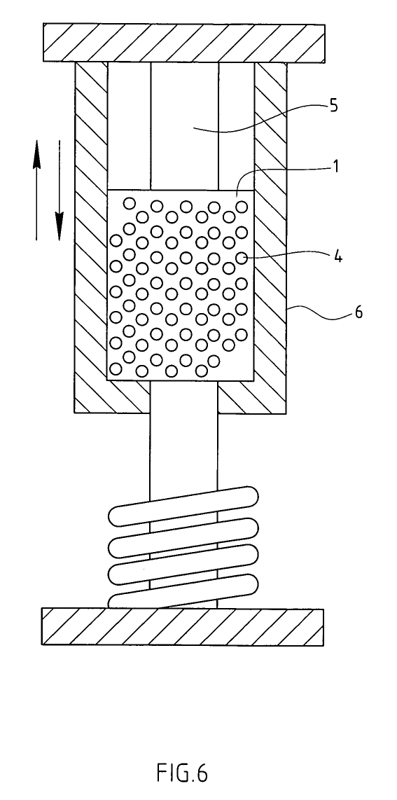

As shown in FIG. 6, the bearing retainer 1 is placed on the axle 5, and a housing 6 is placed on its outside. The movement is created by the friction between the steel ball 4 of the bearing retainer 1, and the housing to move up and down.

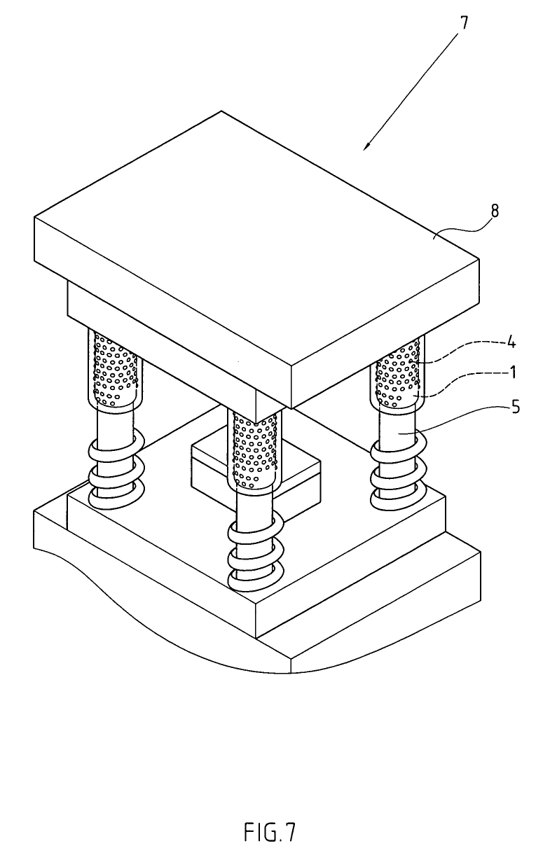

As shown in FIG. 7, in an embodiment of the present invention, the bearing retainer 1 is placed on the moving axles of the press 7. When the upper mold 8 is moving down, it moves down with axle 5. The structure for buffer and guide is the dual steel ball bearing retainer. Because the steel ball moves along the dual row, one goes in and one goes out orderly when it moves up and down; hence, when the dual steel ball bearing retainer moves up and down, the friction is smaller and it moves smoother. Moving along the dual track makes it easy to be taken down; therefore, it is more stable. The force of vibration can be reduced to the minimum, and the stability may increase. Moreover, there are more contacting points than on the conventional design; therefore, the pressure on each point decreases relatively, and the shelf life is increased, and the effect is improved as well.

The present invention more practical. Compared to the conventional structure, there are disadvantages of the conventional structure. For example, when the conventional steel ball bearing moves up and down, because of the friction area is large, it vibrates excessively, which reduces the precision. Also, when the structure of single row steel ball bearing that is placed diagonally moves up and down, even through it has larger contacting area and the friction is reduced, the vibration, effect and stability is still insufficient.

There are advantages of the present invention over the conventional structure. First, the steel ball moves along the dual row; therefore, one goes in and one goes out orderly when it moves up and down. Hence, when the dual steel ball bearing retainer moves up and down, the friction is smaller, and it moves smoother. Second, the steel ball bearing retainer moving along the dual track makes it easy to be taken down; therefore, it is more stable, the force of vibration can be reduced to the minimum, and the stability may increase. Third, there are more contacting points than on the conventional structure; therefore, the pressure on each point decreases relatively, and the shelf life is increased and the effect is improved as well.

I claim:

1. A dual steel ball bearing retainer comprising:
a bearing retainer element having a plurality of dual rows of round indentations placed on the bearing retainer element;
a plurality of steel balls placed within said dual rows of round indentations diagonally, each steel ball being placed in an indentation, said bearing retainer element being placed on an axle; and
a housing is placed on an outside of said bearing retainer element, movement thereof being created by friction between each steel ball and said housing moving up and down, each steel ball moving along a dual row of round indentations orderly when moving up and down.
